(19) United States
(12) Patent Application Publication
(10) Pub. No.: US 2003/0135460 A1
(43) Pub. Date: Jul. 17, 2003

(54) Methods for valuing and placing advertising

(76) Inventor: Galip Talegon, Porterville, CA (US)

Correspondence Address: MARK D MILLER, KIMBLE, MACMICHAEL & UPTON, 5260 NORTH PALM AVENUE, SUITE 221, FRESNO, CA, 93704, US

(21) Appl. No.: 10/345,026

(22) Filed: Jan. 14, 2003

Related U.S. Application Data
(60) Provisional application No. 60/349,110, filed on Jan. 16, 2002.

(51) Int. Cl. G06F 17/60

(52) U.S. Cl. 705/40; 705/14

(57) ABSTRACT

Disclosed are methods for valuing and placing advertising segments on the basis of competitive bidding. Publishers having available ad space make that space (segments) available to an intermediary. The intermediary accepts bids from potential advertisers, ranks the bids and awards advertising segments to the bidders according to the rankings. Payments for the placement of advertising may be made on a per-display basis, or on a per click-through or per transaction basis for internet applications. Under these methods, virtually every advertiser will have some level of access to the available ad space. The intermediary continuously updates its lists of available ad space according to numbers and amounts of bids so that, over time, the lists themselves are representative of the rankings of the most popular ad space. The intermediary also continuously organizes and updates the advertising material it receives according to subject matter for access by potential consumers.

### BACKGROUND OF THE INVENTION

1. Field of the Invention

The present invention relates to the placement and payment for advertising, and more particularly to methods through which the value of specific advertising platforms and contexts can be determined, appropriate costs are established for placing different quantities of advertising on such platforms, and advertising space is provided based upon competitive bidding.

2. Description of the Prior Art

There are many forms of traditional advertising including print media (newspapers, magazines and other periodicals or publications), billboards and broadcast media (television, radio and the like). The advent of technology has broadened available avenues for advertising which can now be provided on such media as large screens jumbotron) or changeable lighted displays deployed in sporting arenas or along highways, changeable rotatable banners such as those set up along the sidelines of sporting arenas, screen overlays in television broadcasts, cellular telephones or watches having text and video capabilities, hand held computers, and the like.

The ever-increasing popularity of the internet makes it a highly desirable place for advertisers to market their products and services. Such marketing can be observed by the advertising banners that are associated with widely used internet web sites such as, for example, <www.yahoo.com>, <www.google.com> and the like. These banners are displayed as part of the web pages when they are accessed, usually in or around the borders of the page. In addition, pop-up advertising banners have also recently come into use. Pop-up banners are windows that display advertising over and prevent the user from seeing the underlying web page until the pop-up banner window is either accessed or closed.

The cost and content of standard or pop-up advertising banners has heretofore been controlled by the owner or publisher of the web page or web site. Such publishers establish the cost of placing advertising in these banners which in many cases is prohibitively expensive for otherwise interested advertisers. As a result, only those advertisers with the largest budgets have any chance at receiving advertising space on web banners. In many cases, such advertisers may be required to purchase more advertising space, or commit to a longer advertising period than they may need or want. As a result, advertising space is wasted, smaller advertisers are left out and the publishers lose potential revenue.

At least one company markets internet keywords, not advertising, on a paid basis. Under this system, a higher payment by a participant will result in that participant appearing higher on a list generated by an internet search using the keyword. However, this scheme has nothing to do with advertising, advertising banners or their content which appear on virtually every major web site.

Every advertiser is unique, having unique products and/or services to be marketed. Similarly, every advertising media and web site is also unique, with different media and web sites appealing to the different interests of different people. As a result, the advertising opportunity available on each publisher's space is also unique to each advertiser, depending upon the potential connection between the products and/or services to be marketed, and the potential visitors to the publisher's space or web site. This explains why such products as guns are advertised in hunting publications, and fabrics are advertised in sewing publications.

Because each publisher's space has a different value to different advertisers, it is not possible to satisfy all advertisers by offering one set advertising rate. At present, flat-rates for advertising space has resulted in fewer and fewer different advertisers placing their advertising on publishers' web sites or available media. When the incremental cost of an advertising agency is added to the advertising rate, the resulting expense can be prohibitively high. Many small and medium-sized advertisers only desire to reach a certain minimal level of exposure through advertising, and would be better served by limited but broad access to a publisher's media platform. A significant problem faced by large companies or portals is selling their ad space on their company web sites. They receive millions of visitors each month to their web sites, however they are not able to sell advertising on these pages that are viewed by millions. The reason for that is they have a set rate for their advertising. Most advertisers or small business owners with web sites cannot afford to buy advertising at that rate, and the ones that can afford it choose not to since the return on investment is not attractive. As a result, these large companies and portals lose significant potential advertising revenue that might otherwise be generated.

It is therefore desirable to provide a method by which an advertiser of any size may have access to a publisher's media platform commensurate with the desire and level of exposure sought by the advertiser. Such a method would give advertisers the freedom to determine how much should be spent for a specific advertising campaign on a specific publisher's space.

It is also desirable for publishers to maximize the use of their advertising space by making different portions or segments of such space available at different rates to advertisers.

It is also desirable for advertisers to be able to directly place advertising without having to hire an advertising agency. This would allow the advertiser to choose the publishers he wants to advertise on and also determine how much he is willing to pay for their advertising space.

It is also desirable to establish variable rates for different levels of advertising based upon the demand for the publisher's specific advertising space, thereby giving the advertiser freedom and flexibility to determine how much advertising can be afforded on the publisher's space, with the advertiser knowing that the higher rate he pays, the more displays or segments his advertising will receive on the publisher's space.

### SUMMARY OF THE INVENTION

The present invention addresses the above-described desires by providing methods whereby publishers having ad space make segments of that space available to potential advertisers, and advertisers gain access to the advertising segments through competitive bidding. Under these methods, publishers are able to sell different segments of their platform at different prices on a competitive bidding basis, the prices being determined by such things as quality (e.g., a particular time slot), quantity (i.e., number of segments), viewer response, etc. This gives a level of access to every potential advertiser who can purchase as much or as little of a specific publisher's ad space as desired, according to competitive bidding. The advertiser chooses the publishers he wants to advertise on and also determines how much he is willing to pay for their advertising space. This will result in a benefit to publishers through an increase in the overall use of their available ad space, and will result in a benefit to advertisers by providing at least some level of access to such ad space by any potential advertiser.

In its most basic aspect, the methods of the present invention are available for any advertising space that.can be divided into segments. Those segments can be such easily changed advertising spaces as banners on a web page, changeable displays on a jumbotron screen, changeable overlays on a video broadcast, changeable banners at sports arenas, video displays on cellular telephones, wireless internet, video displays on hand held computer devices, and the like. However, segments as contemplated by the present invention may also include such things as television and radio spots or time slots, or regionally different versions of printed publications. Examples of typical segments would include without limitation a certain number of banner displays on a web site, a certain number of seconds that a television overlay is displayed during a sporting event, a single radio or TV commercial spot in a given time slot, the distribution of a printed publication into a certain geographic region, etc. It is to be appreciated that the methods of the present invention may be used for any technology having available advertising space.

Under a basic method of the present invention, the segments of numerous different publishers are made available to an intermediary by the respective owners of the segments. The intermediary organizes and categorizes the available segments, and makes them available to potential advertisers. This is preferably done on a web site, although any appropriate platform may be used. Through the intermediary, the potential advertiser is able to determine what his advertising dollar will purchase in terms of the available segments. For example, a small number of banner displays (e.g., displays of the advertiser's material per “n” hits on the web page) may be available on a popular web page for the same price as a large number of banners on a less popular web page. In other examples, smaller banners may be less expensive than larger ones, and less popular time slots may be less expensive than prime-time slots. The potential advertiser is able to review the available advertising space or segments, and make decisions regarding which segments they desire to purchase. Then, the advertiser places a bid for the desired segments. In order to make a bid, the advertiser must have appropriate credit or money on deposit with the intermediary. The bidding and response process is an interactive one, and can be accomplished using any appropriate interactive method such as without limitation a web site, e-mail, telephone, facsimile or in-person.

In one aspect of the invention, such a bid may be accepted or rejected depending upon whether and how many other advertisers are also bidding for the same segments. A rejection would indicate that the advertiser has failed to meet the minimum bid required for a single segment. If rejected, the advertiser will be informed as to the cost for a single segment and given the opportunity to bid again.

In another aspect of the invention, the advertiser will be informed that the bid submitted will not purchase the requested segments, but could be used to purchase less expensive alternative segments (e.g. a different sized banner, a banner on a different web page, a banner display at a less popular time, etc.) In this way, an advertiser may be able to afford a bid on less-used advertising space of the publisher, resulting in a win-win with the publisher receiving otherwise lost revenue, and the advertiser being able to place at least some advertising with the publisher.

Once a bid is accepted, the advertising is submitted for review by the publisher so as to avoid republication of scandalous, false or otherwise inappropriate content. Following approval, the advertising is placed on the desired segments. The advertising bidder's account with the intermediary is debited either before or after the advertising is placed, depending upon the requirements of the publisher and the payment method selected. Additional or alternative segments may be bid on and purchased in the same manner.

Through these methods, the advertiser determines how much he will spend to place advertising on the publisher's space knowing that the higher rate he pays, the more displays or segments his advertising will receive on the publisher's ad space. Through competitive bidding, advertisers have the freedom and flexibility to determine how much they are willing to pay for given advertising segments on a specific publisher's advertising space. These methods also help both publishers and advertisers by allowing advertisers learn the cost of advertising on a publisher's web site or publisher's ad space. The methods of the present invention can be applied to large businesses, medium size businesses or small businesses.

Internet and related applications will benefit particularly from these methods since the web site owner can use these methods without having to hire an advertising agency. In internet applications, advertising segments may be in the form of the banners that are displayed with a web page when accessed by a user. The content of these banners may be easily changed such that different content may be displayed each time the web page is accessed. In different aspects of the invention, the advertiser may bid for this space based on: (1) the number of times his advertising is simply displayed to users on the web page (e.g., CPM=cost per 10,000 such displays); or (2) whether or not the user clicks through to the advertising, taking the user to the advertiser's own web site; or (3) whether or not the user enters into a transaction based on access through the advertising. Each of these pricing scenarios would have a different cost, lower costs being associated with simply displaying the advertising, and higher costs being associated with actual transactions generated by the advertising. In a CPM situation, the advertiser pays for the display on the Publisher's web site regardless of whether the web site visitor clicks on the advertising or not. On the other hand, with pay per click-through, the advertiser only pays when the visitor clicks on the banner ad and goes to where the banner directs him. The advertiser does not pay for impressions with this method, but pays when a click through occurs landing the visitor to another site through that banner ad. With payment per action or transaction, the advertiser only pays when a transaction or action occurs as a result of that specific click through (e.g., a purchase was made by filling out a form, a survey was filled out, or a ballot was conducted, etc.).

With these methods, no matter how small or large the advertiser's budget, the advertiser is able to advertise at some level on any given publisher's space. The methods allow all advertisers to advertise within their budget. The value of an advertising space on a publisher's web site is different for each unique advertiser, and using these methods the advertiser is able to valuate a specific publisher's advertising cost based on what the advertiser thinks it should cost.

It is therefore a primary object of the present invention to provide methods for valuing segments of advertising space and making one or more of such segments available to any potential advertiser for the placement of advertising material on a competitive bidding basis.

It is another primary object of the present invention to provide methods that allow access by any potential advertiser to the ability to purchase segments of a given advertising space on a competitive bidding basis.

It is also an important object of the present invention to provide methods that allow advertisers able to establish values for advertising segments in the context of different but specific wide-ranging media.

It is also an important object of the present invention to provide methods that allow advertisers evaluate different costs and values of advertising segments, to set limits (budgets) for advertising costs, and receive advertising placements commensurate with such cost limits.

It is also an important object of the present invention to provide methods for placing advertising segments at different costs that are demand driven based on competitive bidding.

It is a further object of the present invention to provide methods that allow advertisers to share changeable advertising space by allowing different advertisers to place their advertising on selected segments of such space by competitively bidding for such segments.

It is a further object of the present invention to provide methods that allow advertisers to competitively bid for different quantities of changeable advertising segments such as web site banners, television overlays, large screen displays, changeable banners and the like.

It is a further object of the present invention to provide methods that allow advertisers to competitively bid for different traditional advertising segments based on time or location such as television or radio spots, publications in certain geographical regions, and the like.

It is a further object of the present invention to provide methods that allow advertisers fair access to wide ranging publishing space (segments) on a competitive bidding basis.

It is a further object of the present invention to provide methods that allow advertisers, not publishers, to establish the value of advertising segments through a competitive bidding process.

Additional objects of the invention will be apparent from the detailed descriptions and the claims herein.

### DETAILED DESCRIPTION OF A PREFERRED EMBODIMENT

By way of example and without limiting the appended claims, in an internet advertising situation, a typical method of the present invention generally calls for a publisher (in this example, a large company or portal with ten million or more visitors to their web sites) to sign up with the intermediary for the placement of advertising on its space, which include web page banners and the like. The publisher contacts the intermediary, preferably through the intermediary's web site, finds the industry/sector from a list of categories that most closely match the publisher's company and opens an account. The publisher provides the intermediary with important information such as web traffic analysis, statistics of the publisher, web pages where the publisher wants to sell advertising, etc.

The Publisher is then directed to one of the intermediary's web pages where the publisher is asked to copy and paste a special code into the html section of the publisher's web pages containing the ad space where the banner ads are to be placed. This code allows the intermediary to access and display advertising on these banners from the intermediary's own server. The publisher has the option of placing the code at that moment, or placing it later since it will also be provided via e-mail.

Next, the publisher selects one of the payment distribution methods to receive its portion of the payments made by advertisers. Since the intermediary sells the advertising space on behalf of the publisher and charges the advertisers directly, the intermediary first collects the funds from the advertisers, and then transfers or distributes an agreed amount to the publishers according to whatever payment method is selected. Accordingly, the publisher picks a method of accrual (such as pre-pay, or pay per click-through), and a method of payment by the intermediary (such as direct deposit to his account or check by mail, etc.). The Publisher may also establish a minimum acceptable bid amount for each advertising space he is selling, although this is not required. If the publisher chooses not to set a minimum acceptable bid, the minimum bid will be defaulted to some small amount such as one cent ($0.01) or one dollar ($1.00). In this case, anyone that places a bid that is equal to or higher than the minimum will have his advertising displayed on the Publisher's web site as long as the advertiser obeys the regulations and terms set by the intermediary and agreed by the publishers. Publishers using the method cannot discriminate. They cannot deny competitors from advertising on their web site. However, the publishers can monitor who the advertisers are, what is being advertised, and reject inappropriate subject matter (e.g., sexually explicit, false, scandalous, hazardous, or dangerous materials or subjects, etc.).

In this example, when potential advertisers come to the intermediary's web site, they are able to explore the site and see models and demonstrations. The advertiser can select from different categories and learn which publishers are selling advertising space on the intermediary's site. If the advertiser sees a publisher whose advertising space they desire to access, the advertiser registers with the intermediary in order to bid on the space. This includes providing basic information about the advertiser (names, phone numbers, mailing address, email address, etc.) and then establishing an account through which payment for advertising will be accomplished. This may be a credit line, deposit account, or other satisfactory payment vehicle. Funds will be taken from the account to cover the expenses incurred by that advertiser in placing advertisements with different publishers.

Thereafter, the advertiser is redirected to another web page where he is instructed regarding uploading of his banners onto the servers of the intermediary. The advertiser can later add, edit, and assign banners to be used for different ad campaigns. At this point, the advertiser is ready to place a bid to advertise on any publisher's web site that is listed with the intermediary.

In this example, which uses payment per CPM, the advertiser first identifies the specific advertising space or segments of a publisher that the advertiser desires to place advertising. The advertiser then places an amount, referred to as a “bid,” that represents what the advertiser thinks the specific publisher's ad space should cost according to the advertiser. Every advertiser seeking to place advertising on the same publisher's space has the flexibility and the freedom to determine the amount for which they pay per CPM (cost per 10,000 impressions). The higher the amount, the higher the frequency (more segments) that the advertiser's banner ad will be displayed on a banner ad rotation on the publisher's web site. The bidder enters the amount and, in this example, it is accepted and placed into the pool along with the bids of other advertisers. When the bids are closed, they are then ranked and a calculation is performed to determine how many segments should be allocated to each bidder, according to rank. Since this is a CPM example, all bidder accounts are charged as soon as the bidding is closed, and the publisher is paid according to its agreement with the intermediary.

By way of example only and without limitation to the appended claims, if ABC Company is the publisher, X Company and Y Company are the advertisers that wish to advertise on ABC Company's web site banners. X Company has a larger advertising budget than Y Company, so X Company places a bid of $11.85 per CPM to advertise on ABC Company's web site. Y Company places a bid of $0.65 per CPM to advertise on the same space on ABC Company's web site. Assuming that there are total of 149 advertisers participating in this campaign, upon reaching the deadline for placing bids for this particular space, it turns out that X Company is ranked #1 and Y Company is ranked #149. The intermediary will calculate the frequency for each advertiser's banner ad displays on the publisher's web site based on their rank, each of which will be different. Thus, X Company, having placed the highest bid is ranked #1, and will receive the highest frequency of its banner ads being displayed on the publisher's site (e.g., perhaps every fourth hit). Meanwhile, Y Company having placed the lowest bid and receiving the lowest ranking, will receive the lowest frequency (e.g., perhaps every 18,929^{th} hit).

Since the banners are displayed on the Publisher's site through a rotating banner mechanism, the intermediary determines whose banner should be displayed on the rotation according to calculations made based on the dollar amounts of the bids and the rankings (from the highest bid to the lowest bid). The one with the highest bid is the highest ranked advertiser (ranked #1), and will receive more frequencies than the others. The ones that come after him on the ranking will receive lesser frequencies, as the lowest ranked advertiser will have the least frequency. As can be seen in this example, the bidding only sets the ranking of the advertisers which relates to the frequency of ad displays or segments. It is not a real auction (winner take all) since every bidder with a minimum bid gets to advertise.

If the advertising campaign lasts one month, within that month, from among all the participating advertisers, the highest ranked advertiser will have his banner ad shown on the publisher's web site more times than any of the other participants. Depending upon the number of hits that occur during the month, it is possible that some of the participating advertisers will not have any of their paid banner ads displayed on the Publisher's web site within that period simply because they have lower frequencies and are ranked lower. In this situation, these lower ranked advertisers' paid banner ads may simply be forfeited, or they may be automatically transferred to the ad campaign for the next period, to be displayed on that same publisher's web site. Since there is a new advertising period, such advertisers have the chance to increase their bids relative to the new period to try to increase their frequency of display. Of course, many of the original advertisers are also likely to participate again, and potentially new advertisers may also participate, so it is not possible for the advertiser to know what change in ranking, if any, may be achieved by increasing his bid. In highly competitive situations, an increased bid may result in simply staying at the same rank, or may actually result in a loss in rank (which loss would have been greater were the bid not increased). It is also possible for all advertisers to place new bids, make changes to their bids, or edit their banners. When this time expires, all placed bids are locked and the ranking is again determined. The frequency is calculated for each participant, the advertiser accounts are charged, and the ad campaign starts again.

Other embodiments of the invention are more suitable for use with medium or small sized companies whose web pages are not as popular or well known. The present invention may be applied in three different ways for medium and small sized publishers which can offer advertising through the intermediary on a pay per CPM, pay per click-through, or pay per transaction basis. The publisher selects the single payment method that best fits its situation, the three payment methods being mutually exclusive (i.e., the advertising space will only be offered under one of the three payment options). If the publisher is large or well known, the CPM method described previously may be the most profitable. However, if the publisher is not well known, it may not be able to obtain very high CPM rates, and may be more interested in offering its advertising space on a click-through or pay per transaction basis. This is appealing to the advertiser because it only has to pay if there is a click-through or a transaction.

If pay per transaction is made available by the publisher and is selected by the advertiser, it is also of significant secondary value to advertisers. Using pay per transaction, the invention offers the advertisers a large sales force solution that is essentially free of cost. The advertisers only pay a commission after a sale is conducted (transaction) without having to hire a sales team to do the selling for them. With pay per transaction, the publisher only receives payment for advertising when a visitor is redirected to the advertiser's web site and that same visitor actually initiates a transaction (e.g. the purchase of goods or services, sending an e-mail, filling out a survey, etc.). In such a case, the advertiser's bid results in actual sales, and not just marketing. This whole concept creates a valuable sales force to the advertiser. He does not have to pay for anything until a transaction (sale of goods or services) takes place. Such charges may be billed each time a transaction occurs or at the end of the advertising period.

For any of the payment methods, the publisher relinquishes its advertising space to be divided up among the bidders. However, in the pay per click-through or pay per transaction options, the number of segments allocated to each advertiser is directly proportional to the relationship of their bid amount to the total of all bids. This translates into the number of segments or displays that will be made using the advertiser's material. For example, if the ad space is available on a pay transaction basis, and there are five advertisers, each bidding $10.00 per transaction, there will be a 5-banner rotation with each advertiser receiving equal segments (one out of every five). However, if four of the advertisers bid $10.00 and the fifth bids $20.00, then there will be a six-segment rotation, with the fifth bidder receiving two out of every six segments, and the others receiving only one out of every six segments. Thus, the bid amount determines the proportional number of segments that will be displayed using the advertiser's material. Then, only if there is a transaction will the advertiser be charged his bid amount. This same example also applies to the click-through option, with the bid amount determining the number of display segments, and an actual click-through resulting in a charge to the advertiser.

An added benefit to advertisers is also provided by the methods of the present invention as a result of its use over time. As more and more publishers make their ad space (segments) available, and more and more advertisers bid on that space, a natural ranking of the most popular advertising space will take place. Since the advertising bidders are also the owners or the top executives of the businesses they own or work for, they are the natural experts in the sector or the industry they work in. Accordingly, they are in the best position to know or rank which of the businesses in their sectors are the most reputable, or the top performers that offer quality and best products or services. So when such advertisers use the present methods, they actually contribute by assisting in the ranking of publishers. The intermediary keeps track of the number and amount of bids made for particular ad space or market sectors (e.g. keywords), and continuously organizes and updates the lists of available ad space according to this data. Thus, when an advertiser searches through the intermediary's web site for advertising platforms in particular market sectors, the more popular publishers will come out first, followed in order by lesser ranked publishers based on the same criteria.

Since the present methods can be used as a self-serve tool and business owners can easily use it without having to hire an ad agency, the invention gives business owners the power, freedom and flexibility to choose what businesses (publishers) they should place their bids on, and how much their bids should be for each publisher. Based on historical data, in the intermediary's search engine, when a potential publisher enters a term identifying particular goods or services, it can learn the names of all the businesses that sell or provide the specific goods or services entered. Similarly, when a potential advertiser searches the web site of the intermediary, the search results are organized according to the number of advertisers that had placed bids on the publisher, as well as by the amount of the bids that were placed. The larger the number of bidders and/or the higher the amounts of the bids for a given publisher, the higher the publisher will be ranked in the search results. This saves considerable time and energy, and provides valuable information to those who access and search the intermediary, since those who care the most—the business experts in the relevant market—are the ones placing the bids which determine the ranking.

In addition, as the number of advertisers working through the intermediary increases, an ever increasing list of products and services will develop. Eventually, this list may be accessed by potential purchasers who want to identify products and/or services that have an established track record through the intermediary. Thus the intermediary itself may act as a smart clearing house for potential purchasers of products and services.

Accordingly, the present invention creates a self serve market place for selling and buying advertising without fear of rejection regardless of the price the advertiser is willing to pay. In addition to providing an advertising market place for the placing of advertising, the present invention also serves as a sales force team for advertisers, and as an accurate search engine for information regarding the popularity of advertising space and advertised products and services.

The invention is invented to be used with all different technologies including Internet, wireless, and other telecommunication, satellite, nano, or other technologies that have been or are yet to be created. The technology is not limited to any mentioned or non-mentioned technologies that may be invented in the future.

It is to be appreciated that the methods described herein may be applied to numerous different advertising and published media including without limitation cellular telephones, video billboards, television, radio, periodicals, magazines, newspapers and the like, as well as with telecommunication, satellite, nano or other technologies that have been or are yet to be created. It is also to be appreciated that different combinations of the several methods described herein may be used in combination with each other.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A method for placing the advertising material of at least one advertiser into advertising space segments of at least one publisher comprising the steps of:
a. at least one publisher relinquishing control of segments of its advertising space to an intermediary;
b. at least one advertiser contacting said intermediary and
(1) selecting available advertising space for placement of its advertising material; and
(2) submitting a bid to the intermediary for placement of said advertising material on segments of said selected space;
c. the intermediary ranking bids received from each advertiser; and
d. the intermediary placing the advertising material of each advertiser onto segments of the available advertising space according to the ranking of said bids.

2. The method of claim 1 wherein said segments of available advertising space are selected from the group consisting of: web site banners, lighted displays, jumbotron screens, rotating banners, television overlays, television spots, radio spots, and regional editions of printed publications.

3. The method of claim 1 including the additional steps of:
e. said at least one advertiser establishing an account with said intermediary;
f. said intermediary deducting payment for the placement of the advertising material of said advertiser from said account; and
g. said intermediary transferring a portion of the payment from said advertiser to said publisher.

4. The method of claim 3 wherein the advertising space relinquished by said at least one publisher is made available through said intermediary according to a method selected from the group consisting of: CPM, pay per click-through, and pay per transaction.

5. The method of claim 1 including the additional steps of said intermediary organizing and ranking the publishers of advertising space according to the number of bids submitted by advertisers for such space, and making such organization and ranking available for inspection.

6. The method of claim 1 including the additional steps of said intermediary organizing and ranking the publishers of advertising space according to the dollar amounts of bids submitted by advertisers for such space, and making such organization and ranking available for inspection.

7. The method of claim 5 including the additional steps of said intermediary organizing and ranking the publishers of advertising space according to the dollar amounts of bids submitted by advertisers for such space, and making such organization and ranking available for inspection.

8. The method of claim 7 including the additional steps of said intermediary organizing advertising material provided by advertisers and making such organized material available for inspection.

9. A method for marketing goods and services without hiring a sales staff comprising the steps of:
a. an intermediary receiving control of segments of at least one publisher's advertising space for use on a pay-per-transaction basis;
b. at least one advertiser contacting said intermediary, selecting the advertising space for said pay-per-transaction publisher, and submitting a bid per transaction for the placement of advertising material on said space;
c. the intermediary ranking bids received from each advertiser for said space; and
d. the intermediary placing the advertising material of each advertiser onto segments of said advertising space according to the ranking of said bids.

10. The method of claim 9 including the additional steps of:
e. said at least one advertiser establishing an account with said intermediary;
f. said intermediary deducting said bid amount from said account as payment for the placement of the advertising material of said advertiser onto said space each time a transaction is generated by said placement; and
g. said intermediary transferring a portion of the payment from said advertiser to said publisher.

11. A method for determining the popularity of different advertising space comprising the steps of:
a. an intermediary receiving control of segments of advertising spaces form a plurality of publishers;
b. the intermediary receiving bids from advertisers for the purpose of placing advertising material of said advertisers onto such spaces;
c. the intermediary organizing and ranking bids received from advertisers for each such space; and
d. the intermediary making the organization and ranking information for each such space available for inspection.

12. A method for determining the popularity of different products and services comprising the steps of:
a. an intermediary receiving control of segments of advertising spaces from a plurality of publishers;
b. the intermediary receiving bids from advertisers for the purpose of placing advertising material of said advertisers onto such spaces;
c. the intermediary organizing the advertising material received from said advertisers according to subject matter; and
d. the intermediary making the organization of such advertising material available for inspection.

13. A method for placing the advertising material of at least one advertiser into advertising space segments of at least one publisher through an intermediary comprising the steps of:
a. the intermediary receiving control of segments of the at least one publisher's advertising space;
b. the intermediary receiving a contact by at least one advertiser, said contact including the steps of
(1) selecting available advertising space for placement of the advertising material of said at least one advertiser; and
(2) submitting at least one bid to the intermediary for placement of said advertising material on segments of said selected space;
c. the intermediary ranking bids received from each advertiser; and
d. the intermediary placing the advertising material of each advertiser onto segments of the available advertising space according to the ranking of said bids.

14. The method of claim 13 including the additional steps of:
e. said at least one advertiser establishing an account with said intermediary;
f. said intermediary deducting payment for the placement of the advertising material of said advertiser from said account; and
g. said intermediary transferring a portion of the payment from said advertiser to said publisher.

15. The method of claim 14 wherein the advertising space of said at least one publisher is made available through said intermediary according to a method selected from the group consisting of: CPM, pay per click-through, and pay per transaction.
